(19) United States
(12) Patent Application Publication
(10) Pub. No.: US 2016/0054997 A1
(43) Pub. Date: Feb. 25, 2016

(54) COMPUTING SYSTEM WITH STRIDE PREFETCH MECHANISM AND METHOD OF OPERATION THEREOF

(71) Applicant: Samsung Electronics Co., Ltd., Suwon-si (KR)

(72) Inventors: Arun Radhakrishnan, Austin, TX (US); Karthik Sundaram, Austin, CA (US); Brian Grayson, Austin, CA (US)

(21) Appl. No.: 14/832,547

(22) Filed: Aug. 21, 2015

Related U.S. Application Data
(60) Provisional application No. 62/040,803, filed on Aug. 22, 2014.

(51) Int. Cl. G06F 9/30; G06F 9/345; G06F 12/08

(52) U.S. Cl. CPC G06F 9/30047; G06F 12/0862; G06F 9/3455; G06F 2212/602

(57) ABSTRACT

A computing system includes: an instruction dispatch module configured to receive an address stream; a prefetch module, coupled to the instruction dispatch module, configured to: train to concurrently detect a single-stride pattern or a multi-stride pattern from the address stream, speculatively fetch a program data based on the single-stride pattern or the multi-stride pattern, and continue to train for the single-stride pattern with a larger value for a stride count or for the multi-stride pattern.

### CROSS-REFERENCE TO RELATED APPLICATION(S)

This application claims the benefit of U.S. Provisional Patent Application Ser. No. 62/040,803 filed Aug. 22, 2014, and the subject matter thereof is incorporated herein by reference thereto.

### TECHNICAL FIELD

An embodiment of the present invention relates generally to a computing system, and more particularly to a system for stride prefetch.

### BACKGROUND

Modern consumer and industrial electronics, such as computing systems, servers, appliances, televisions, cellular phones, automobiles, satellites, and combination devices, are providing increasing levels of functionality to support modern life. While the performance requirements can differ between consumer products and enterprise or commercial products, there is a common need for more performance while reducing power consumption.

Research and development in the existing technologies can take a myriad of different directions. Caching is one mechanism employed to improve performance. Prefetching is another mechanism used to help populate the cache. However, prefetching is costly in memory cycle and power consumption.

Thus, a need still remains for a computing system with prefetch mechanism for improved processing performance while reducing power consumption through increased efficiency. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides an apparatus, including: an instruction dispatch module configured to receive an address stream; a prefetch module, coupled to the instruction dispatch module, configured to train to concurrently detect a single-stride pattern or a multi-stride pattern from an address stream, speculatively fetch a program data based on the single-stride pattern or the multi-stride pattern, and continue to train for the single-stride pattern with a larger value for a stride count or for a multi-stride pattern.

An embodiment of the present invention provides a method including: training to concurrently detect a single-stride pattern or a multi-stride pattern from an address stream; speculatively fetching a program data based on the single-stride pattern or the multi-stride pattern; and continuing to train for the single-stride pattern with a larger value for a stride count or for a multi-stride pattern.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a computing system with prefetch mechanism in an embodiment of the present invention.

FIG. 2 is an example of prefetch training information and prefetch pattern information.

FIG. 3 is an example of an architectural view of an embodiment.

FIG. 4 is an example of an architectural view of the atoms as states.

FIG. 5 is an example of a simplified architectural view of the atoms.

FIG. 6 is an example of an architectural view of the atoms with state transitions.

FIG. 7 is an example of an architectural view of FIG. 3 for a two-stride pattern detection.

FIG. 8 is an example of an architectural view of FIG. 3 for three-stride and a four-stride pattern detection.

FIG. 9 is an example of a flow chart for a training process for the prefetch module.

FIG. 10 provides examples of the computing system as application examples with the embodiment of the present invention.

FIG. 11 is a flow chart of a method of operation of a computing system in an embodiment of the present invention.

### DETAILED DESCRIPTION

Various embodiments provide a computing system or a prefetch module to detect arbitrary complex patterns accurately and quickly without predetermined patterns. The adding of the training states and the representative shifting of the atoms allows for continued training as patterns changes in the address stream.

Various embodiments provide a computing system or a prefetch module with rapid fetching/prefetching while improving pattern detection. Embodiments can quickly start speculatively prefetching or fetching program datas as a single-stride pattern while the prefetch module can continue to train for a longer single-stride pattern or a multi-stride pattern. The pattern threshold can be used to provide rapid deployment of the training entry for fetching/prefetching a single-stride pattern. The multi-stride threshold can be used to provide rapid deployment of the training entry for fetching/prefetching a multi-stride pattern.

Various embodiments provide a computing system or a prefetch module with improved pattern detection by auto-correlation with the addresses. The multi-stride detectors and the comparators therein can be used to auto-correlate patterns based on the address in the address stream. The auto-correlation allows for detection for the trailing edge in the address stream within a region even in the presence of accesses at the leading edge unrelated to the pattern that precedes the pattern.

Various embodiments provide a computing system or a prefetch module with improved pattern detection by continuously comparing the trailing edge of the address stream. Embodiments can process the address stream with the atoms. This allows embodiments to avoid being confused or missing spurious accesses for the program datas or the address at the beginning of the address stream.

Various embodiments provide a computing system or a prefetch module with reliable detection of patterns in the address stream that is area and power-efficient for hardware implementation. The utilization of one training entry for a single-stride pattern detection or a multi-stride pattern detection uses hardware for both purposes avoiding redundant hardware. The utilization of one training entry with multiple training states uses the same hardware for information shared across both single-stride pattern detection and multi-stride pattern detection, such as the tag or the last training address. The avoidance of redundant hardware circuitry leads to less power consumption.

Various embodiments provide a computing system or a prefetch module that efficiently use the training states or atoms for concurrent single-stride pattern detection while providing shorter time to perform speculative fetching/prefetching. Embodiments can transfer or copy the training entry when the pattern threshold is met allowing for speculatively fetching/prefetching. However, the embodiments can continue to train for longer stride for the same single-stride pattern allowing use of the same training state and atom. This also has the added benefit of efficient power and hardware savings.

Various embodiments provide a computing system or a prefetch module that is extensible to detect complex patterns in the address stream by extending the number of comparators used in a multi-stride detector.

The following embodiments are described in sufficient detail to enable those skilled in the art to make and use the invention. It is to be understood that other embodiments may be evident based on the present disclosure, and that system, process, architectural, or mechanical changes can be made to the embodiments as examples without departing from the scope of the present invention.

In the following description, numerous specific details are given to provide a thorough understanding of the invention. However, it will be apparent that the invention and various embodiments may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, an embodiment can be operated in any orientation.

The term “module” referred to herein can include software, hardware, or a combination thereof in an embodiment of the present invention in accordance with the context in which the term is used. For example, the software can be machine code, firmware, embedded code, application software, or a combination thereof. Also for example, the hardware can be circuitry, processor, computer, integrated circuit, integrated circuit cores, a pressure sensor, an inertial sensor, a microelectromechanical system (MEMS), passive devices, or a combination thereof. Additional examples of hardware circuitry can be digital circuits or logic, analog circuits, mixed-mode circuits, optical circuits, or a combination thereof. Further, if a module is written in the apparatus claims section below, the modules are deemed to include hardware circuitry for the purposes and the scope of apparatus claims.

The modules in the following description of the embodiments can be coupled to one other as described or as shown. The coupling can be direct or indirect without or with, respectively, intervening between coupled items. The coupling can be physical contact or by communication between items.

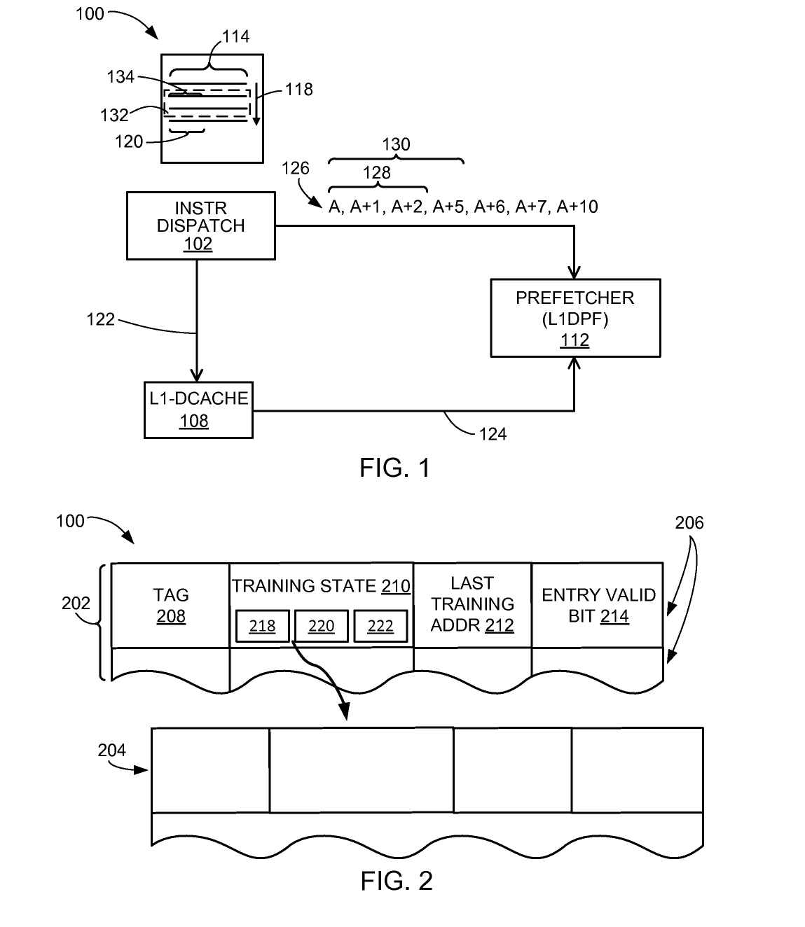

Referring now to FIG. 1, therein is shown a computing system 100 with prefetch mechanism in an embodiment of the present invention. FIG. 1 depicts a portion of the computing system 100. As an example, FIG. 1 can depict a prefetch mechanism for the computing system 100. The prefetch mechanism can be applicable to a number of memory hierarchies within the computing system 100, external to the computing system 100, or a combination thereof

The memory hierarchies can be organized in a number of ways. For example, the memory hierarchies can be tiered based on access performance, dedicated or shared access, size of memory, internal or external to the device or part of a particular tier in the memory hierarchy, nonvolatility or volatility of the memory devices, or a combination thereof

As a further example, FIG. 1 can also depict a prefetch mechanism for various types of information or data. For example, FIG. 1 can depict a prefetch mechanism for information access to be used for operation of the computing system 100. Also for example, FIG. 1 can depict a prefetch mechanism for instruction access or data access. For brevity and without limiting the various embodiments, the computing system 100 will be described with regard to the purpose of data access.

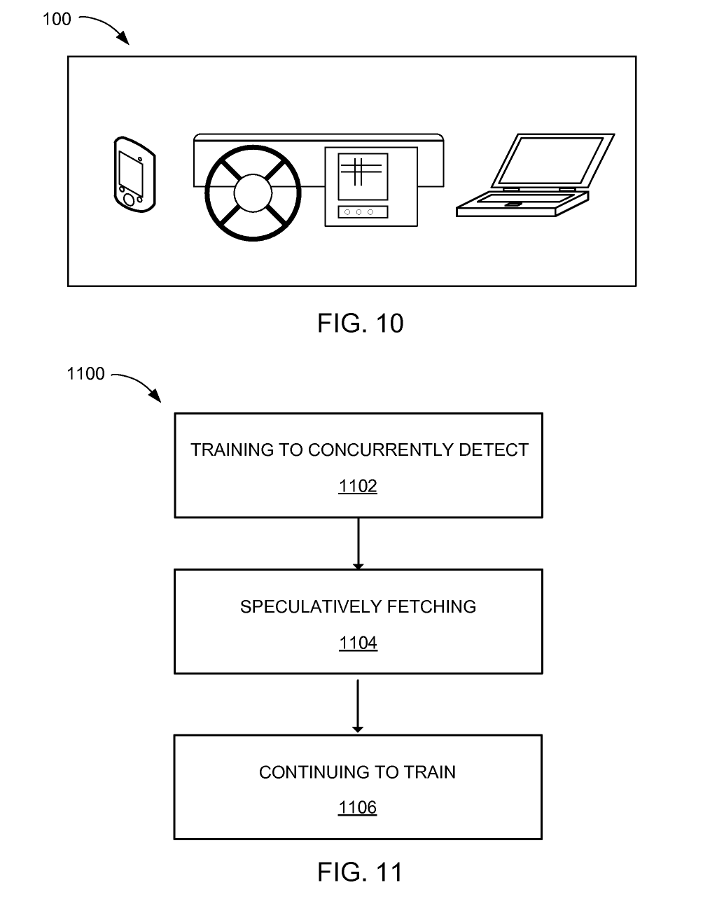

As an example, FIG. 1 depicts a portion of a computing system 100, such as at least a portion of a processor, a central processing unit (CPU), a graphics processing unit (GPU), a digital signal processor (DSP), or a hardware circuit with computing capability, which can be implemented with an application specific integrated circuit (ASIC). These applications of the computing system 100 can be shown in the examples in FIG. 10 and other portions shown throughout this application.

As further examples, various embodiments can be implemented on a single integrated circuit, with components on a daughter card or system board within a system casing, or distributed from system to system across various network topologies, or a combination thereof. Examples of network topologies include personal area network (PAN), local area network (LAN), storage area network (SAN), metropolitan area network (MAN), wide area network (WAN), or a combination thereof

Returning to the example shown, FIG. 1 depicts an instruction dispatch module 102 a cache module 108, and a prefetch module 112. As noted earlier, these modules can be implemented with software, hardware circuitry, or a combination thereof. The remainder of the description for FIG. 1 describes the functionality, as examples, of the modules but more about the operation of some of these modules are described in subsequent figures. Also noted earlier, the computing system 100 is described with regards to the purpose of instruction access as an example. For brevity and clarity, other portions of the computing system 100 are not shown or described, such as the instruction load, execution, and store.

The instruction dispatch module 102 can retrieve or receive program data 114 from a program store (not shown) containing the program with a program order 118 for execution. The program data 114 represents at least a portion of one line of executable code for the program. For example, the program data 114 can include operational codes (“opcodes”) and operands. The opcodes provide the actual instruction to be executed while the operand provides the data opcodes operates upon. The operand can also include designation where the data is, for example, register identifier or memory address.

The program order 118 is the order in which the program data 114 are retrieved by the instruction dispatch module 102. As an example, each of the program data 114 can be represented by an address 120 that can be sent to the cache module 108, the prefetch module 112, or a combination thereof. Also for example the address 120 can refer to the data or operand in which the opcode can operate upon. For brevity and without limiting the various embodiments, the computing system 100 will be described with the address 120 referring to data address.

The address 120 can be unique to one of the program data 114 in the program. As examples, the address 120 can be expressed as a virtual address, a logical address, a physical address, or a combination thereof.

Also for example, the addresses 120 can be within a region 132 of addressable memory of the program store. The region 132 is a portion of addressable memory space for a portion of the program data 114 for the program. The region 132 can be a continuous addressable space. A region 132 have a starting address referred to as a region address 134. The region 132 can also have a region size that is continuous.

The instruction dispatch module 102 can also invoke a cache look-up 122 with the cache module 108. The cache module 108 provides a more rapid access to information or data relative to other memory devices or structures in a memory hierarchy. The cache module 108 can be for the program data 114.

In an example where the computing system 100 is a processor, the cache module 108 can include multiple levels of cache memory, such as level one (L1) cache, level 2 (L2) cache, etc. The various levels of cache can be internal to the computing system 100, external to the computing system 100, or a combination thereof.

In an embodiment where the computing system 100 is an integrated circuit processor, the L1 cache can be within the integrated circuit processor and the L2 cache can be off-chip. In the example shown in FIG. 1, the cache module 108 can be a L1 instruction cache or a L1 cache for the opcode portion of the program data 114 and not necessarily for operand portion.

For this example, the cache module 108 can provide a hit-miss status 124 for the program data 114 being requested by the instruction dispatch module 102. The hit-miss status 124 indicates if the requested address 120 or program data 114 is in the cache module 108, such as in an existing cache line. If it is, the hit-miss status 124 would indicate a hit, otherwise a miss.

When the hit-miss status 124 indicates a miss, the computing system 100 can retrieve the missed program data 114 from the next memory hierarchy beyond the cache module 108. As an example, the prefetch module 112 can fetch or retrieve the missed program data 114. This instruction fetch beyond the cache module 108 typically involves long latencies compared to a cache hit.

Further, the cache miss can prevent the computing system 100 from continued execution while the instruction dispatch module 102 waits for the missing program data 114 to be retrieved or received. This waiting affects the overall performance of the computing system 100. The cache module 108 can send the hit-miss status 124 to the prefetch module 112.

The prefetch module 112 can also train with unique cache-line accesses from the cache module 108, the address 120, or a combination thereof. For example, the prefetch module 112 avoids using repeated caches hits or repeated cache misses for training The prefetch module 112 can be trained for single stride pattern or multi-stride pattern based on the history of the program data 114 being requested.

As an example, the pattern detection scheme inspects the addresses 120 requested by the instruction dispatch module 102 or for the unique cache accesses to the cache module 108. The pattern detection scheme can check to see if there are any patterns in those addresses 120. To accomplish this, the prefetch module 112 determines if the addresses 120 for past instruction accesses have at least one repeating pattern. For example, the addresses 120 from an address stream 126 A, A+1, A+2 have a pattern, where the addresses 120 for subsequent accesses are being incremented by one.

The address stream 126 is the addresses 120 received or retrieved by the instruction dispatch module 102, accesses to the cache module 108, or a combination thereof. As an example, the address stream 126 can be the addresses 120 in the program order 118. Also for example, the address stream 126 can also deviate from the program order 118 in certain circumstances, such as branches or conditional executions of program data 114. Further for example, the address stream 126 can represent unique cache-hits or unique cache misses to the cache module 108 for the program datas 114 or the addresses 120.

The prefetch module 112 can use the training to speculatively fetch/prefetch or send out requests for the program data 114 that can be requested by the instruction dispatch module 102 in the future or currently for the example for a cache miss. The requests are fetches or can be also referred to as prefetches to other tiers of the memory hierarchy beyond the cache module 108. In other words, these data fetches or prefetches by the prefetch module 112 brings the program data 114 from a location far from the processing core of the computing system 100 to a closer location. As an example, the program data 114 received from these fetches can be sent to the cache module 108, the instruction dispatch module 102, or a combination thereof

Continuing with the earlier example, if the prefetch module 112 recognizes or detects a pattern in the address stream 126, then the prefetch module 112 can speculate or determine that the next access would be to A+3, A+4, A+5. The prefetch module 112 can retrieve the program data 114, even before the instruction dispatch module 102 has made an actual request for the program data 114 from that address 120.

The patterns to be detected can be referred to as a single-stride pattern 128 and a multi-stride pattern 130. The single-stride pattern 128 is a sequence of addresses 120 in the address stream 126 used for training where the difference in the value of adjacent addresses 120 is the same within that sequence. The multi-stride pattern 130 include at least two sequences of addresses 120 in the address stream 126 used for training where within each sequence the difference in value between adjacent address 120 is the same but the difference between the adjacent sequences differ. These detections will be described more in subsequent figures.

Referring now to FIG. 2, therein is shown an example a prefetch training information 202 and a prefetch pattern information 204. In various embodiments, the prefetch training information 202 represents the information populated with the training operation by the prefetch module 112 of FIG. 1. The training allows the prefetch module 112 to detect the single-stride pattern 128, the multi-stride patterns 130, or a combination thereof from the history of the address stream 126 of FIG. 1.

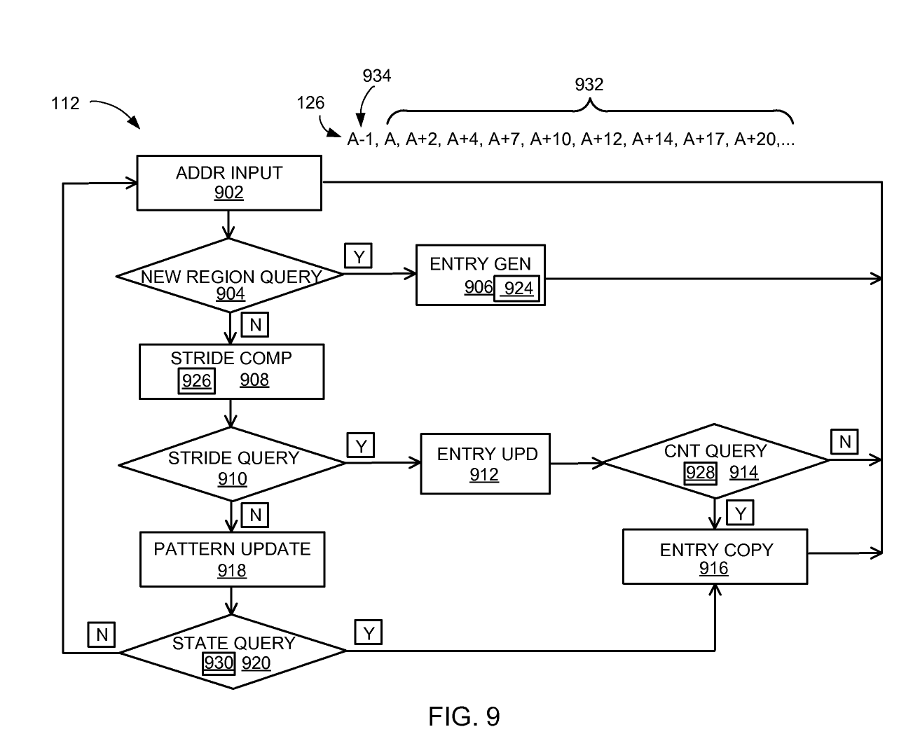

In various embodiments, the prefetch pattern information 204 represents the information utilized by the prefetch module 112 to speculatively fetch program data 114. As an example, the speculatively fetching can be from a memory hierarchy beyond the cache module 108 of FIG. 1. Also for example, the prefetch pattern information 204 can be populated based on the training by the prefetch module 112 with the address stream 126 of past accesses. As a more specific example, the prefetch pattern information 204 can be populated with the information from the prefetch training information 202, which is described in more detail in FIG. 9.

The prefetch training information 202 and the prefetch pattern information 204 can be implemented in a number of ways. For example, the prefetch training information 202 and the prefetch pattern information 204 can be organized as a table in storage elements in the prefetch module 112. As another example, the prefetch training information 202 and the prefetch pattern information 204 can be implemented as register bit in a finite state machine (FSM) implemented with hardware circuits, such as digital gates or circuitry.

Examples of the storage elements can be volatile memory, nonvolatile memory, or a combination thereof. Examples of volatile memories include static random access memories (SRAM), dynamic random access memories (DRAM), and read-writeable registers implemented with digital flip-flops. Examples of nonvolatile memories include solid state memories, Flash memories, and electrically erasable programmable read-only memories (EEPROM).

Now, an example is described for the prefetch training information 202. The prefetch training information 202 can include a number of training entries 206, such as N number of training entries 206 where N can be a value of one or more than one. The training entries 206 can provide information and allows for tracking of the training operation by the prefetch module 112. The training operation can be for detection of the single-stride pattern 128, the multi-stride pattern 130, or a combination thereof.

For various embodiments, each of the training entries 206 can include a tag 208, training states 210, a last training address 212, an entry valid bit 214, or a combination thereof. The tag 208 can be used as an indicator or a demarcation for a memory space for detecting a pattern. As an example, the tag 208 can represent the region address 134 of FIG. 1 for a memory space or a region of memory where the program data 114 are being accessed. Returning the example in FIG. 1, the tag 208 can include or be assigned the region address 134 for the region with the address 120 “A”.

In various embodiments, the training states 210 are used for detecting patterns from the history of the program data 114 from the address stream 126. For example, each of the training entries 206 can utilize one of the training states 210 for detecting one single-stride pattern 128. As a further example, each of the training entries 206 can utilize multiple training states 210 for detecting at least one multi-stride pattern 130. More is described about the utilization of the training states 210 in subsequent figures.

As an example, each of the training states 210 can include a stride increment 218, a stride count 220, a state valid bit 222, or a combination thereof. The stride increment 218 is used to detect a pattern in the address stream 126. As a specific example, the stride increment 218 provides the difference in address values between adjacent addresses 120 in the address stream 126 used for training.

In a single-stride pattern 128 example, the difference can be a distance in the cache lines in the cache module 108 from the previous cache miss. As an example, the single-stride pattern 128 is a sequence of addresses 120 from the address stream 126 used for training where the stride increment 218 is the same between adjacent addresses 120 in this sequence. In a multi-stride pattern 130 example, the calculation for difference can involve more than two cache lines to help detect a multi-stride pattern 130. As an example, the multi-stride pattern 130 includes at least two sequences of addresses 120 from the address stream 126 used for training where the stride increment 218 is the same between the adjacent addresses 120 for each of the sequence but differ between adjacent sequences.

If the stride increment 218 remains the same value over a number of adjacent pairs of addresses 120 in the address stream 126, then a pattern can be potentially detected. More about the stride increment 218 is described in subsequent figures. As a more detailed example, the stride increment 218 is computed within a region of program address space.

As an example, the stride count 220 provides a record of the repetition of the same value for the stride increment 218 before the difference between adjacent addresses 120 in the address stream 126 changes. The change is determined based on comparison of the difference with the previous adjacent pair(s) of addresses 120 of FIG. 1. Further for example, as long as the stride increment 218 remains the same between adjacent pairs of addresses 120, then the stride count 220 can continue to increment for that instance of stride increment 218. More about the stride count 220 is described in subsequent figures.

As an example, the state valid bit 222 can indicate which of the training states 210 in the prefetch training information 202 include information used for detecting patterns from the address stream 126. The state valid bit 222 can also indicate which of the training states 210 do not include information for detecting patterns or should not be used for detecting patterns.

In various embodiments, the last training address 212 is used help detect a single-stride pattern 128, a multi-stride pattern 130, or a combination thereof based on the history of the address stream 126. As an example, the last training address 212 is used as an offset within a region as demarked by the region address 134 stored as the tag 208. As a further example, the last training address 212 can also be used to determine the stride increment 218, the stride count 220, or a combination thereof from the address stream 126. More about the last training address 212 is described in FIG. 9.

In various embodiments, the entry valid bit 214 can indicate which of the training entries 206 in the prefetch training information 202 include information used for detecting patterns from the address stream 126. The entry valid bit 214 can also indicate which of the training entries 206 do not include information for detecting patterns.

The following further describes the relationship between the prefetch training information 202 and the prefetch pattern information 204. Portions of the prefetch training information 202 can be transferred to the prefetch pattern information 204 allowing the prefetch module 112 to speculatively fetch additional program data 114 based the pattern(s) detected thus far.

The prefetch module 112 can continue to train with the address stream 126 and update or modify or add to the prefetch training information 202. The update or modification can be to the portion already transferred to the prefetch pattern information 204. The update or modification can be with new portions from the prefetch training information 202 not yet transferred to the prefetch pattern information 204.

For example, the prefetch pattern information 204 can receive at least one of the training entries 206 allowing the prefetch module 112 to fetch program data 114 based on single-stride pattern 128. Further, the prefetch module 112 can continue to determine those particular training entries 206 should be updated or if the single-stride pattern 128 is part of a multi-stride pattern 130.

Continuing with this example, the prefetch module 112 can increase the stride count 220 even after the transfer to the prefetch pattern information 204 if the stride increment 218 remains the same for subsequent addresses 120 in the address stream 126. In this example, the transferred training entries 206 can be updated from the prefetch training information 202 to the prefetch pattern information 204.

As a further example, the prefetch module 112 can continue to train and can calculate a different stride increment 218 than for the value of the stride increment 218 for the training entries 206 already transferred to the prefetch pattern information 204. The additional training states 210 for those training entries 206, which have been transferred, can be also sent to the prefetch pattern information 204. This can allow for the prefetch module 112 to dynamically adapt the speculative fetch to new patterns detected for any training entries 206 already transferred. More about the relationship between the prefetch training information 202 and the prefetch pattern information 204 is described in subsequent figures.

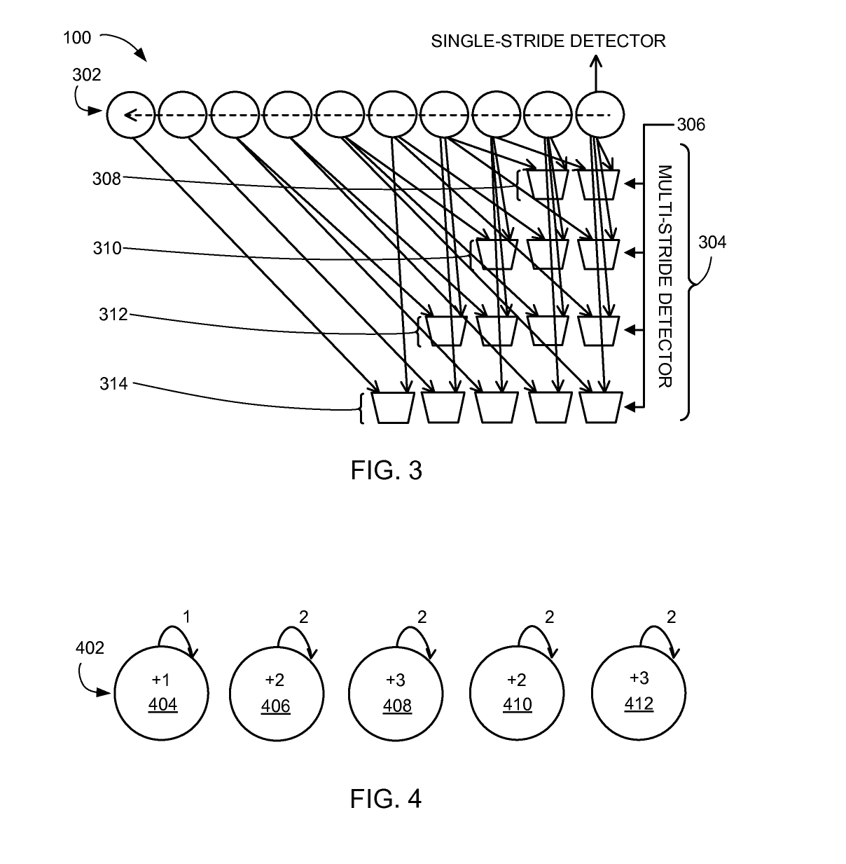

Referring now to FIG. 3, there is shown an example of an architectural view of an embodiment. FIG. 3 depicts an example of an architectural representation of the training and detection of a single-stride pattern 128 and multi-stride pattern 130(s), which can occur concurrently. The training and detection being concurrent refers to the computing system 100 training to detect both single-stride pattern 128 and the multi-stride pattern 130 without any predetermination of what or which is being sought. FIG. 3 can be an example of an architecture view for an operation of the prefetch module 112 of FIG. 1.

As an example, FIG. 3 can depict one of the training entries 206 of FIG. 2 from the prefetch training information 202 of FIG. 2. Also as an example, FIG. 3 can depict one of the training entries 206 copied or transferred to the prefetch pattern information 204 of FIG. 2 to be used for speculatively fetching of the program data 114 of FIG. 1.

Atoms 302 are depicted as ovals along the top of FIG. 3. Each of the atoms 302 represents one of the training states 210 of FIG. 2. As an example, each oval can represent one of the atoms 302. Also for example, each of the atoms 302 can used to detect a single-stride pattern 128. Further for example, a plurality of atoms 302 can also be used to detect one or more multi-stride pattern 130.

As an example, rows of multi-stride detectors 304 are shown below the atoms 302. Since there are a number of multi-stride detectors 304 depicted in FIG. 3, different multi-stride patterns 130 can be detected. This detection can occur sequentially or concurrently/simultaneously. The concurrent detection of different multi-stride patterns 130 refers to detection of numerous patterns that are not predetermined and the detection process occurs at the same time or in parallel.

The multi-stride detectors 304 work with the atoms 302 to detect one or more multi-stride patterns 130, if existing. As an example, each multi-stride detector 304 can include comparators 306. Each of the comparators 306 compares multiple atoms 302 to see if there is a match. If there is a match, then a multi-stride pattern 130 is detected for that multi-stride detector 304.

As an example, a multi-stride pattern 130 is detected when there is a match by all the comparators 306 for one of the multi-stride detectors 304. The detected multi-stride pattern 130 is based on the atoms 302 being compared as well as the location of the atoms 302.

Also for example, a match is partially determined if the stride increment 218 of FIG. 2 and the stride count 220 of FIG. 2 from each of the atoms 302 being compared are the same. If the stride increment 218, the stride count 220, or a combination thereof differs, then there is not a match or there is a mismatch. A mismatch indicates that a multi-stride pattern 130 is not detected for that multi-stride detector 304.

The combination of the comparators 306 for each multi-stride detector 304 helps detect the multi-stride pattern 130. As an example, the multi-stride pattern 130 is determined by the separation between the matching atoms 302 with the stride increment 218 and the stride count 220 in each matching atoms 302. As a specific example, the separation of the atoms 302 being compared for each comparator 306 for each multi-stride detector 304 also helps determine the match. The separation helps determine not only a repetition for a pair of stride increment 218 and stride count 220 but also when or if they occur elsewhere in the multi-stride pattern 130.

As an example, the multi-stride detectors 304 can include up to an n-stride detector(s). An n-stride detector can detect a pattern with n-unique stride increments 218. The “n” can represent the number of patterns with “n” different stride increment 218 or the “n” different patterns for the same stride increment 218.

Also as an example, the number “n” can also represent the number of comparators 306 for that multi-stride detector 304. Also as an example, “2 n” can represent the number of atoms 302 being compared for the n-stride detector.

As a specific example, FIG. 3 depicts the multi-stride detectors 304 including a two-stride detector 308, a three-stride detector 310, a four-stride detector 312, and a five-stride detector 314. The number of strides depicted are shown as examples and do not limit the number of strides detectable by the prefetch module 112 of FIG. 1.

Continuing with the example, the two-stride detector 308 includes two comparators 306. Each of these comparators 306 compares two atoms 302. The two atoms 302 being compared are not the same atoms 302 for each of the comparators 306. The four atoms 302 are being compared by the two-stride detector 308.

Similarly as an example, the three-stride detector 310 compares two atoms 302 with three comparators 306 and the pair of atoms 302 differ between the comparators 306. Six atoms 302 are being compared by the three-stride detector 310 and the pair of atoms 302 differs between the comparators 306. The four-stride detector 312 compares two atoms 302 with four comparators 306 and the pair of atoms 302 differ between the comparators 306.

Continuing with the example, eight atoms 302 are being compared by the four-stride detector 312 and the pair of atoms 302 differs between the comparators 306. The five-stride detector 314 compares two atoms 302 with five comparators 306 and the pair of atoms 302 differ between the comparators 306. Ten atoms 302 are being compared with the five-stride detector 314 and the pair of atoms 302 differs between the comparators 306.

For illustrative purposes, each comparator 306 is shown comparing two atoms 302, although it is understood that each comparator 306 can compare a different number of atoms 302. As an example, each comparator 306 can compare three, four, five, or other integer number of atoms 302.

Also for illustrative purposes, all the comparators 306 are depicted as comparing the same number of atoms 302. Although, it is understood that the comparators 306 can compare different number of atoms 302 from other comparators 306. As an example, each multi-stride detector 304 can compare a different number of atoms 302 with its comparators 306 relative to the comparators 306 in other multi-stride detectors 304. Also as an example, the comparators 306 for one multi-stride detector 304 can compare different numbers of atoms 302 from one comparator 306 to another.

Further for illustrative purposes, the prefetch module 112 is shown with different multi-stride detectors 304 for training, detecting, or both for multi-stride patterns 130. Although it is understood that the prefetch module 112 can be implemented differently. For example, the prefetch module 112 can be implemented with one multi-stride detector 304 and the number of comparators 306.

Continuing with the example, the comparators 306 can be dynamically changed in regards to which atoms 302 feed each comparator 306 for comparison. The dynamic change can depend on how many atoms 302 correspond to the training states 210 with the state valid bit 222 of FIG. 2. Also for example, the number of atoms 302 or which atoms 302 to be compared by any one particular comparator 306 can also dynamically change based on the permutations of the multi-stride pattern 130 being sought or trained. Further for example, computing system 100 can be implemented as a quantum computer whereby qu-bits can be used to implement the prefetch module 112 whereby all permutations of the atoms 302 and the comparators 306 can be operated on to detect any multi-stride pattern 130 up to a stride number up equal to the number of comparators 306.

The comparators 306 can be implemented in a number of ways. For example, each of the comparators 306 can be implemented with combinatorial logic or Boolean comparison to match the values for the stride increment 218 and the stride count 220 for the atoms 302 being compared. As another example, the comparators 306 can also be implemented as a counters or FSM to load and count down for the stride increment 218 and the stride count 220.

Referring now to FIG. 4, therein is shown an example of an architectural view of the atoms 302 as states 402. The states 402 can represent stages for an implementation example, such as in finite state machines (FSM). Each of the atoms 302 represented as one of the states 402 can include the stride increment 218, the stride count 220, or a combination thereof.

In this representation as an example, the stride count 220 is shown as the number along the arc and the stride increment 218 is shown within the atom 302. As described in FIG. 3, the architecture view shows the atoms 302 to represent the training states 210 of FIG. 2.

As a specific example, the atoms 302 can include a first atom 404, a second atom 406, a third atom 408, a fourth atom 410, and a fifth atom 412. The first atom 404 is depicted as the leftmost atom while the fifth atom 412 is depicted as the rightmost atom.

In this example, the first atom 404 is shown with the stride increment 218 with a value 1 and the stride count 220 with a value 1. The second atom 406 is shown with the stride increment 218 with a value 2 and the stride count 220 with a value 2. The third atom 408 is shown with the stride increment 218 with a value 3 and the stride count 220 with a value 2.

Continuing with this example, the fourth atom 410 is shown with the stride increment 218 with a value 2 and the stride count 220 with a value 2. The fifth atom 412 is shown with the stride increment 218 with a value 3 and the stride count 220 with a value 2.

As an example, the atoms 302 can be implemented with hardware circuitry, such as a digital logic FSM with the atoms 302 as the states 402 in the FSM. Also for example, the FSM implementation can also be implemented in software.

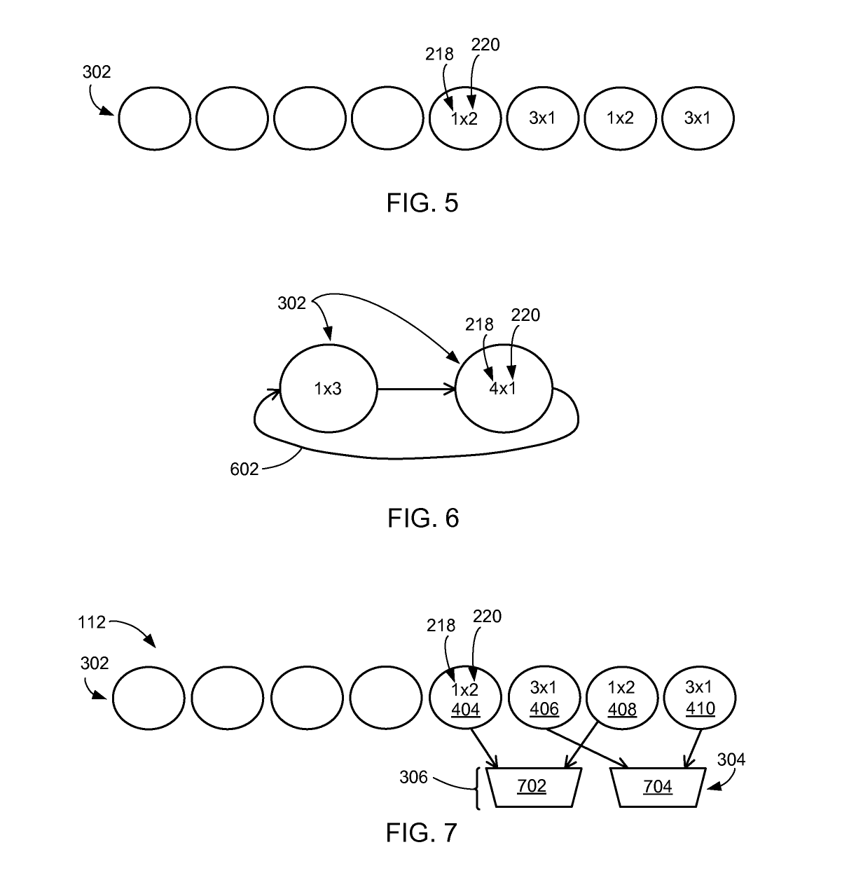

Referring now to FIG. 5, therein is shown an example of a simplified architectural view of the atoms 302. FIG. 5 illustrates another architecture representation of the atoms 302 annotated with a×b, where a represents the stride increment 218 and b represents the stride count 220.

Referring now to FIG. 6, therein is shown an example of an architectural view of the atoms 302 with state transitions 602. The example shown in FIG. 6 depicts the atoms 302 similar to how they are depicted in FIG. 5 with the stride increment 218 and the stride count 220 notated within each of the atoms 302.

FIG. 6 also depicts an example of how the atoms 302 can operate with each other to detect a multi-stride pattern 130. The state transitions 602 can represent an example of a portion of an implementation with a FSM as similarly described in FIG. 4, either with hardware circuitry or with software.

Starting with the atom 302 at the left-hand side, the atom 302 is shown for a training state 210 of FIG. 2 with the value 1 for the stride increment 218 of FIG. 2 and with the value 3 for the stride count 220. Describing FIG. 6 as a FSM implementation, the prefetch module 112 of FIG. 1 can utilize this atom 302 to help detect a multi-stride pattern 130.

In this example, FIG. 6 can detect a multi-stride pattern 130 with a sequence of adjacent addresses 120 of FIG. 1 from the address stream 126 of FIG. 1 having a difference of 1, which is the stride increment 218. Continuing with this example, this atom 302 is utilized for this difference to be repeated 3 times, which is the stride count 220.

Once the stride increment 218 is repeated by the stride count 220, the prefetch module 112 can continue to attempt detecting this particular multi-stride pattern 130 with the state transition 602 going from the left-most atom 302 to the right-most atom 302 as depicted in FIG. 6.

In this example, the right-most atom 302 is shown for a different training state 210 than the one for the left-most atom 302. The right-most atom 302 is shown with the value 4 for the stride increment 218 and with the value 1 for the stride count 220.

Continuing with this example, once the stride increment 218 is repeated by the stride count 220 for the right-most atom 302, the prefetch module 112 can continue to attempt detecting this particular multi-stride pattern 130 with the state transition 602 looping back to the left-most atom 302. In this example, the prefetch module 112 can detect a multi-stride pattern 130 that has a stride increment 218 of 1 repeated 3 times followed by a stride increment 218 of 4 only once.

The multi-stride pattern 130 detection is described without depicting the multi-stride detectors 304 for clarity and brevity. The comparisons for the stride increments 218 and stride counts 220 are described without depicting the comparators 306 of FIG. 3 for clarity and brevity.

For illustrative purposes, the multi-stride pattern 130 being detected is described with the left-most atom 302 followed by the right-most atom 302 then looping back to the left-most atom 302. Although, it is understood that the multi-stride pattern 130 being detected can start with the right-most atom 302 then to the left-most atom 302 and back to the right-most atom 302.

Referring now to FIG. 7, therein is shown an example of an architectural view of FIG. 3 for a two-stride pattern detection. As an example, FIG. 7 depicts an example of part of the training process by the prefetch module 112 of FIG. 1. Each of the atoms 302 depicted in this figure can correspond to one of the training states 210 of FIG. 2. The atoms 302 can be associated with one of the training entries 206 of FIG. 2. Also for example, FIG. 7 depicts the atoms 302 including a first atom 404, a second atom 406, a third atom 408, and a fourth atom 410.

For ease of description, the first atom 404 is described as representing the training state 210 when the prefetch module 112 is starting to detect a single-stride pattern 128 or a multi-stride pattern 130 from the address stream 126 of FIG. 1. The first atom 404 is shown with a value 1 for the stride increment 218 and a value 2 for the stride count 220, similar to the notation described in FIG. 5.

In this example, the prefetch module 112 can continue to train with the training state 210 represented by the first atom 404 until the stride increment 218 changes. When this change occur, the first atom 404 can be viewed as shifted to the left while the prefetch module 112 continues to attempt to detect a multi-stride pattern 130. At this point, the prefetch module 112 can use another training state 210 for the same training entry 206 of FIG. 2 and this additional training state 210 can be represented by the second atom 406.

Continuing with this example, the second atom 406 or this training state 210 can be used to detect another stride increment 218 and another stride count 220. The second atom 406 is depicted with a value 3 for the stride increment 218 and with a value 1 for the stride count 220. As with the transition from the first atom 404 to the second atom 406, a transition to the third atom 408 occurs when the prefetch module 112 determines a different stride increment 218 from that for the second atom 406.

When a second change to the stride increment 218 is determined, the first atom 404 and the second atom 406 can be viewed as shifting over one towards the left allowing for the prefetch module 112 to continue to train utilizing the third atom 408. The third atom 408 can represent a further training state 210 for the same training entry 206 as for the first atom 404 and the second atom 406. The prefetch module 112 utilizes the third atom 408 to detect a stride increment 218 with a value 1 and a stride count 220 with a value 2.

Continuing with this example, the prefetch module 112 can determine yet another change to the stride increment 218. At this point, the prefetch module 112 can utilize a fourth atom 410 to continue to train for detecting a multi-stride pattern 130. As similarly described earlier, this additional change to the stride increment 218 from that for the third atom 408, the first atom 404 through the third atom 408 can be viewed as shifting over one towards the left. In this example, the fourth atom 410 is shown with a value 3 for the stride increment 218 and with a value 1 for the stride count 220.

In addition to the atoms 302, FIG. 7 also depicts one multi-stride detector 304. In this example, the multi-stride detector 304 is shown with two comparators 306. For ease of description, the comparators 306 can be further described as a first-2 s comparator 702 and a second-2 s comparator 704. The first-2 s comparator 702 is shown as the left-most comparator and the naming convention represents a first comparator for a two-stride (2 s) pattern. The second-2 s comparator 704 is shown as the right-most comparator and the naming convention represents a second comparator for a two-stride (2 s) pattern.

In this example, both the first-2 s comparator 702 and the second-2 s comparator 704 are shown each comparing two atoms 302 to detect a two-stride pattern. The first-2 s comparator 702 compares the first atom 404 with the third atom 408. The second-2 s comparator 704 compares the second atom 406 and the fourth atom 410. A multi-stride pattern 130, or as in this example a two-stride pattern, is detected when the first-2 s comparator 702 and the second-2 s comparator 704 both determine a match. The match is determined as described in FIG. 3.

For this example, the two-stride pattern that is detectable by the prefetch module 112 is 1, 1, 3, 1, 1, 3 where these numbers represents the stride increments 218 for this two-stride pattern. The repetition for the stride increments 218 prior to a change is the stride count 220 for its corresponding atom 302 or training state 210. The address stream 126 can be A, A+1, A+2, A+5, A+6, A+7, A+10 similar to the notation used in FIG. 1.

For illustrative purposes, the prefetch module 112 is described in this example as being trained and detecting a two-stride pattern. Although, it is understood that the prefetch module 112 in this example can be for training and detecting a single-stride pattern 128. For example, the prefetch module 112 can detect 1, 1 as a single-stride pattern 128. Further, the prefetch module 112 can transfer the training entry 206 for this single-stride pattern 128 from the prefetch training information 202 of FIG. 2 to the prefetch pattern information 204 of FIG. 2. As described earlier, the prefetch module 112 can utilize the prefetch pattern information 204 to speculatively fetch program data 114 of FIG. 1 while continue to train to detect a multi-stride pattern 130. As in this example, for a two-stride pattern.

Also for illustrative purposes, the prefetch module 112 is shown to detect 1, 1, 3, 1, 1, 3, although it is understood that the prefetch module 112 can train to detect different patterns from the address stream 126. For example, the prefetch module 112 can detect different patterns for one or more single-stride pattern 128s or different patterns for the two-stride pattern.

The atoms 302 or the training states 210 can be implemented in a number of ways. In addition to the possible hardware implementations described in FIG. 2, the atoms 302 or the training states 210 can be implemented with storage elements or register or flip flops. These hardware circuitry can also include shift registers for shifting the atoms 302 or the training states 210 during the training process.

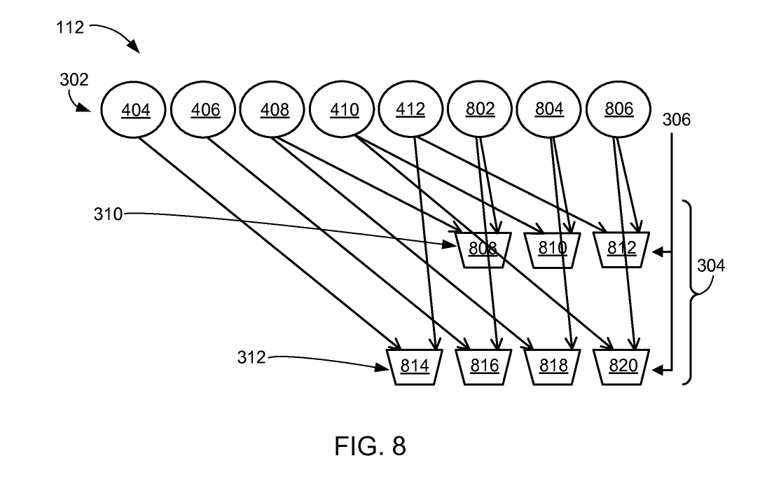

Referring now to FIG. 8, therein is an example of an architectural view of FIG. 3 for a three-stride and a four-stride pattern detection. As an example, FIG. 7 depicts an example of part of the training process by the prefetch module 112 of FIG. 1. As a further example, FIG. 7 can depict an example of a continuation of the training process from FIG. 7 or a training process separate from the two-stride pattern detected and described in FIG. 7.

For brevity, FIG. 8 is will described as a continuation of the training process described in FIG. 7 with using the same element names from FIG. 7 where appropriate. FIG. 8 can represent a continuation of FIG. 7 where a two-stride pattern was not detected and the prefetch module 112 continues to train to attempt to detect a three-stride pattern, a four-stride pattern, or a combination thereof. The training to detect these multi-stride patterns 130 can occur simultaneously or concurrently. Also for example, FIG. 8 can depict the continued training by the prefetch module 112 for other multi-stride patterns 130 even if the two-stride pattern was trained or detected.

As similarly described in FIG. 7, FIG. 8 can depict the atoms 302. These atoms 302 can be part of one of the training entries 206 of FIG. 2. Each of the atoms 302 can represent one of the training states 210 of FIG. 2.

In the example shown in FIG. 8, the prefetch module 112 has progressed beyond the training with just the first atom 404, the second atom 406, the third atom 408, and the fourth atom 410, as discussed in FIG. 7. FIG. 8 also depicts additional atoms 302 based on the continued training process including a fifth atom 412, a sixth atom 802, a seventh atom 804, and an eighth atom 806.

Each of these atoms 302 are associated with their own stride increment 218 of FIG. 2 and stride count 220 of FIG. 2. The values for the stride increment 218 between adjacent atoms 302 will differ from one another.

In addition to the atoms 302, FIG. 8 depicts two multi-stride detectors 304. In this example, the multi-stride detectors 304 include a three-stride detector 310 and a four-stride detector 312. The three-stride detector 310 attempts to detect at least one three-stride pattern from the address stream 126 of FIG. 1. The four-stride detector 312 attempts to detect at least one four-stride pattern from the address stream 126.

For illustrative purposes, FIG. 8 is described with the prefetch module 112 training to detect a three-stride pattern, a four-stride pattern, or a combination thereof. Although it is understood that FIG. 8 does not limit the function of the prefetch module 112. For example, FIG. 8 can represent the prefetch module 112 training to detect these multi-stride patterns 130 but does not preclude the prefetch module 112 from speculatively fetching program data 114 of FIG. 1. The speculative fetching can be for at least one single-stride pattern 128 or at least one two-stride pattern transferred to the prefetch pattern information 204 of FIG. 2.

In this example, the three-stride detector 310 includes three comparators 306, referred to as a first-3 s comparator 808, a second-3 s comparator 810, and a third-3 s comparator 812. The naming convention follows as described in FIG. 7. The four-stride detector 312 can include four comparators 306 referred to as a first-4 s comparator 814, a second-4 s comparator 816, a third-4 s comparator 818, and a fourth-4 s comparator 820.

In this example, a three-stride pattern is detected when the first-3 s comparator 808, the second-3 s comparator 810, and the third-3 s comparator 812 determine a match. Also, a four-stride pattern is detected when a first-4 s comparator 814, a second-4 s comparator 816, a third-4 s comparator 818, and a fourth-4 s comparator 820 determine a match. The match is determined as described in FIG. 3.

As a specific example, the three-stride detector 310 compares the third atom 408 through an eighth atom 806 with its comparators 306. The first-3 s comparator 808 compares the third atom 408 with the sixth atom 802 to determine its match or mismatch. The second-3 s comparator 810 compares fourth atom 410 with the seventh atom 804 to determine its match or mismatch. The third-3 s comparator 812 compares the fifth atom 412 with the eighth atom 806 to determine its match or mismatch. The comparison operations are described in FIG. 3.

Also as a specific example, the four-stride detector 312 compares the first atom 404 through the eighth atom 806 with its comparators 306. The first-4 s comparator 814 compares the first atom 404 with the fifth atom 412 to determine its match or mismatch. The second-4 s comparator 816 compares second atom 406 with the sixth atom 802 to determine its match or mismatch. The third-4 s comparator 818 compares the third atom 408 with the seventh atom 804 to determine its match or mismatch. The fourth-4 s comparator 820 compares the fourth atom 410 with the eighth atom 806 to determine its match or mismatch. Similarly, these comparison operations are described in FIG. 3.

Referring now to FIG. 9, therein is shown an example of a flow chart for a training process for the prefetch module 112 of FIG. 1. The flow chart is an example of a process where the prefetch module 112 of FIG. 1 populates the prefetch training information 202 based on a history of the program data 114 of FIG. 1 retrieved and from the address stream 126 of FIG. 1.

The flow chart also provides triggers of when information from the prefetch training information 202 is transferred to the prefetch pattern information 204 of FIG. 2. This allows the prefetch module 112 to speculatively fetch the program data 114 while optionally continue to train for a longer single-stride pattern 128 or for multi-stride pattern(s) 130. The longer single-stride pattern 128 refers to the stride count 220 being larger in value than what has been copied or transferred to the prefetch pattern information 204.

In this example, the flow chart can include the following steps: an address input 902, a new region query 904, an entry generation 906, a stride computation 908, a stride query 910, an entry update 912, a count query 914, an entry copy 916, a pattern update 918, and a state query 920. As an example, the flow chart can be implemented with hardware circuitry, such as logic gates or FSM, in the prefetch module 112. Also as an example, the flow chart can also be implemented with software and executed by a processor (not shown) in the prefetch module 112 or elsewhere in the computing system 100.

For various embodiments, the address input 902 receives or retrieves the program data 114. The address input 902 can receive or retrieve the addresses 120 of FIG. 1 as part of the address stream 126. The address input 902 can also filter multiple accesses to the same address 120. As an example, multiple accesses to the cache module 108 of FIG. 1 can be viewed as a single access regardless of the hit-miss status 124 of FIG. 1. This single access can be used for training the prefetch module 112. The flow can progress to the new region query 904.

The new region query 904 determines if the address 120 being processed is for a new region 132 of FIG. 1 or within the same region for the address 120 previously processed from the address stream 126. If the address 120 is for a new region 132, then the flow can progress to the entry generation 906. If the address 120 is within the same region or not in a new region 132, then the flow can progress to the stride computation 908. As an example, the new region query 904 can compare a specific set of the bits of the address 210. If two data-accesses have the same set of specific address bits, then they are considered to be part of the same region.

Continuing to the entry generation 906, this step can generate or utilize a new training entry 206 of FIG. 2 in the prefetch training information 202 of FIG. 1 for the new region 132. The entry generation 906 can set the entry valid bit 214 of FIG. 2 to indicate that this training entry 206 has valid training information.

The entry generation 906 can utilize or assign an initial training state 210 of FIG. 2 for this new training entry 206. The entry generation 906 can set the state valid bit 222 of FIG. 2 to indicate that this training state 210 has valid training information.

The entry generation 906 can also assign the tag 208 of FIG. 2 for the training entry 206 to a region address 134 for the new region 132. As an example, the region address 134 can be the address 120 found to be the start of the new region 132. The region address 134 would point to the region 132 of FIG. 1, associated with the address 120. Multiple addresses 120 could map to the same region 132. In general the region address 134 can include the top few bits of the address 120.

The entry generation 906 can further assign the last training address 212 of FIG. 2 for the training entry 206 to a region offset 924. The region offset 924 is the difference between the address 120 and the region address 134. The region offset 924 is currently the address 120 found to be at the start of the new region 132. As a specific example, for a 4 k region, bits 11:6 of the address 120, could indicate the region offset 924.

The entry generation 906 can continue by assigning the stride count 220 of FIG. 2 to be zero for the training state 210 for the new region 132. The flow can progress to loop back to the address input 902 to continue to process the address stream 126 and the next address 120.

Returning to the branch from the new region query 904 for not a new region 132, the stride computation 908 can compute a difference 926 between the address 120 just received and the address 120 last received, which can be the last training address 212. The last training address 212 is for the training entry 206, the training state 210, or a combination thereof being used by the prefetch module 112 for training The flow can progress to the stride query 910.

The stride query 910 can determine if the stride increment 218 for the training state 210 needs to be initially set with the difference 926 following a generation for the training entry 206 just formed for the new region 132. The stride query 910 can also determine if the difference 926 matches a value for the stride increment 218 for the training state 210 of the training entry 206 that is not for a new training entry 206 just formed for the new region 132. If either of the above is yes, then the flow progresses to the entry update 912. If neither of above applies, then the flow can progress to pattern update 918.

The entry update 912 updates the stride increment 218 with the difference 926 for the address 120 received after the generation of the training entry 206 just formed for the new region 132. The address 120 can be greater than or equal to or less than the last training address 212. The stride increment 218/stride count 220 might need to be updated for the greater than or less than scenarios, but not for the equal scenarios. The stride count 220 can be incremented when the stride increment 218 is not changed.

The last training address 212 can be updated with the region offset 924 or in this example with the address 120, which is the previous value of the last training address 212 plus the stride increment 218 times the current stride count 220. The stride increments 218 could be calculated either using the region offsets 924 or the addresses 120 directly. In general the region offset 924 within the region 132 can be calculated for every address 120 which maps into the region 132. This region offset 924 could then be used to calculate the subsequent stride. So either the last region offset 924 could be stored or the last training address 212 within the region 132 could be stored. The flow can progress to a count query 914.

The count query 914 determines if a portion of the prefetch training information 202 or more specifically a portion of the training entry 206 can be transferred to the prefetch pattern information 204 for speculative fetching. Embodiments can compare the stride count 220 for the training state 210 used for training to a pattern threshold 928. The pattern threshold 928 can be used to determine if the training entry 206 being used for training can be used for pattern detection, such as detection for the single-stride pattern 128 or the multi-stride pattern 130.

If the stride count 220 meets or exceeds the pattern threshold 928, then the flow can progress to entry copy 916. If not, the flow can loop back to the address input 902 to continue recognize or train to recognize patterns from the address stream 126.

The entry copy 916 can transfer a portion of the training entry 206 being used for training to be used for speculative fetching. The entry copy 916 can copy the training entry 206 from the prefetch training information 202 to the prefetch pattern information 204 to be used for speculative fetching. As a specific example, the training state 210 being used for training can be copied to the prefetch pattern information 204.

If the training entry, the training state 210, or a combination thereof already exists in the prefetch pattern information 204, then this copy can update the prefetch pattern information 204. The flow can loop back to the address input 902 allowing the training entry 206 to remain in the prefetch training information 202 and its continued use to refine the training for pattern detection.

Returning to the branch leading to the pattern update 918, the pattern update 918 can help determine if there is a multi-stride pattern 130. The pattern update 918 is executed when the difference 926 does not match the stride increment 218 in the training state 210 used for training

In various embodiments, the pattern update 918 can utilize another training state 210 for the training entry 206 being used for training As an example, the pattern update 918 can utilize a previously unused training state 210 by setting its state valid bit 222 to indicate a valid training state. The pattern update 918 can assign the stride increment 218 for this training state 210 with the difference 926. Relating back to the earlier figures as examples, the use of another training state 210 can be described as shifting the previous training state 210 or atom 302 to the left as described in FIG. 7.

For brevity, various embodiments are described within the same region such that the tag 208 does not change in value from the previous training state 210 used for training The last training address 212 can be associated with this training state 210 and can be updated similarly as before. As an example, the last training address 212 can be updated with the address 120 for this training state 210. The flow can progress to the state query 920.

The state query 920 can determine if the training entry 206 being used for training is ready for speculative fetching. As an example, the state query 920 determines if the number of training states 210 in the training entry 206 used for training has reached a multi-stride threshold 930 for detection of a multi-stride pattern 130. The multi-stride threshold 930 refers to a value that once the number of training states 210 meets or exceeds this value, then the training entry 206 can be transferred to the prefetch pattern information 204. As a specific example, if the training states 210 cannot detect a multi-stride pattern 130 using either a 2/3/4/5 multi-stride detector 304, then nothing gets transferred to the prefetch pattern information 204.

If so, then this training entry 206 or those training states 210 can be transferred to be used for speculative fetching based on multi-pattern detection. The flow can progress to the entry copy 916 to copy the training entry 206 or these training states 210 from the prefetch training information 202 to the prefetch pattern information 204. If not, the flow can loop back to the address input 902 and the flow can operate with the new valid training state 210 and its respective associated parameters.

As an example of how the prefetch module 112 detects a single-stride pattern 128, consider the address stream 126 A, A+5, A+10, A+15, A+20, etc. The address input 902 initially receives “A” as the address 120. The flow progresses to the new region query 904. The new region query 904 would determine that this address 120 is for a new region 132 and the flow progresses to the entry generation 906.

The entry generation 906 would utilize one of the training entries 206 in the prefetch training information 202 and indicate this by setting the entry valid bit 214. The tag 208 would be assigned the region address 134 for the region with the address 120 “A”.

The last training address 212 would be assigned the address 120 “A” as the region offset. One training state 210 would also be utilized and this would be indicated by setting the state valid bit 222. As an example, the stride increment 218 is zero and the stride count 220 is zero. The flow can loop back to the address input 902.

The address input 902 can then receive or begin the processing of the next address 120 “A+5” from the address stream 126. The flow progresses to the new region query 904 and it would determine that “A+5” is not for a new region then the flow can progress to the stride computation 908.

The stride computation 908 can compute the difference 926 between the address 120 just received, “A+5”, and the previously received address 120 stored in the last training address 212. The flow can progress to the stride query 910.

The stride query 910 can determine that the address 120 “A+5” is after the entry generation 906 for address “A” and the flow can progress to the entry update 912. The entry update can assign the stride increment 218 with the difference 926. The stride count 220 can be incremented by one. The last training address 212 can be assigned this address 120 “A+5” as the region offset. The flow can progress to the count query 914.

For this example, the pattern threshold 928 is assigned to a value 2. So far, with “A+5”, the stride count 220 is 1 and that value does not meet the pattern threshold 928 to transfer this training entry 206 to the prefetch pattern information 204 for speculatively fetching. The flow can loop back to the address input 902 to continue to process the next address 120 from the address stream 126.

The address 120 is “A+10”. The flow progress similarly as it did for the address 120 “A+5”. The flow passes through the new region query 904 to the stride computation 908. The stride computation 908 calculates the difference to be 5 between the address 120 “A+10” just received and the previously received address 120 “A+5”.

The stride query 910 determines that the difference 926 is the same as the stride increment 218 from the previous calculations and the flow can progress to the entry update 912. The entry update 912 does not need to update the stride increment 218. The entry update 912 can increment the stride count 220 to 2. The entry update 912 can also assign the last training address 212 to the address 120 “A+10”. No changes to the other parameters for this training entry 206. The flow can progress to the count query 914.

In this example, the pattern threshold 928 is set to a value 2. Since the stride count 220 is now 2, this value meets the pattern threshold 928 and the flow can progress to entry copy 916. The value of the pattern threshold 928 being set to 2 can indicate a determination that a single-stride pattern 128 has been detected.

The entry copy 916 can copy or transfer a portion of the training entry 206 to the prefetch pattern information 204. As a specific example, the training state 210 being used for training can be transferred or copied to the prefetch pattern information 204 to be used for prefetching of program data 114 based on the single-stride pattern 128 represented in the training state 210.

The address 120 for the single-stride pattern 128 prefetch is based on the stride increment 218 and the last address 120 received. In this example, the first program data 114 to be prefetch can be for the address 120 “A+10” plus the stride increment 218 5 or “A+15”. This can continue to the stride count 220 or potentially beyond the stride count 220.

The training state 210 transferred or copied to the prefetch pattern information 204 can represent one of the atoms 302 of FIG. 3 or the first atom 404 of FIG. 3. This atom 302 can be represented in a manner as shown in FIG. 4 or in FIG. 5.

Even the entry copy 916 copies this training entry 206, the flow can progress or loop back to the address input 902 to continue to train and detect other stride patterns. The other stride patterns can be a longer single-stride pattern 128 or a multi-stride pattern 130. The continued training for longer single-stride pattern 128 allows for efficient use of already utilized training state 210 or atom 302 and can be viewed as repeat compression to avoid using additional states for the longer single-stride pattern 128.

Continuing with this address stream 126 as an example, the flow can progress to process the next addresses 120 “A+15” and “A+20” similarly as with “A+10” with the last training address 212 and the stride count 220 being updated for each address 120 being processed for training

Further, since the stride increment 218 remains the same, or 5 in this example, the training entry 206 continues to be copied with entry copy 916 to the prefetch pattern information 204 as update. This allows the prefetch module 112 to prefetch the program data 114 with the same stride increment 218 of 5 but with a higher stride count 220 as the prefetch pattern information receives updates for this training entry 206 including the training state 210 with the incremented stride count 220.

As an example for a multi-stride pattern 130 detection, consider the address stream 126 A−1, A, A+2, A+4, A+7, A+10, A+12, A+14, A+17, A+20, etc. The atoms 302 shown in FIG. 4 can represent this address stream 126.

As an initial general overview, a flow can progress for detecting a multi-stride pattern 130 in the same manner as for detecting a single-stride pattern 128 while the stride increment 218 remains the same for the address 120 being processed to the previous address 120 in the address stream 126.

Continuing with the initial overview, once the stride increment 218 changes between adjacent addresses 120, then a different training state 210 is utilized. This training state 210 would represent a different atom 302 and the previous atom 302 used for training would be shift to the left as previously described in earlier figures.

The flow can be described similarly as for the single-stride detection earlier. For brevity, not all the steps for will be described for a single-stride pattern 128 detection. In this example, the description is focused on the multi-stride pattern 130 without describing the possible detection and prefetching of the single-stride pattern 128.

The address input 902 initially receives “A−1” as the address 120. The flow progresses to the new region query 904. The new region query 904 would determine that this address 120 is for a new region 132 and the flow progresses to the entry generation 906.

The entry generation 906 would utilize one of the training entries 206 in the prefetch training information 202 and indicate this by setting the entry valid bit 214. The tag 208 would be assigned the region address 134 for the region with the address 120 “A−1”.

The last training address 212 would be assigned the address 120 “A−1” as the region offset. One training state 210 would also be utilized and this would be indicated by setting the state valid bit 222. As an example, the stride increment 218 can be initially set zero and the stride count 220 can be initially set to zero for the first address 120 in the address stream 126. The flow can loop back to the address input 902.

The address input 902 can then receive or begin the processing of the next address 120 “A” from the address stream 126. The flow progresses to the new region query 904 and it would determine that “A” is not for a new region then the flow can progress to the stride computation 908.

The stride computation 908 can compute the difference 926 between the address 120 just received, “A”, and the previously received address 120 stored in the last training address 212. The flow can progress to the stride query 910.

The stride query 910 can determine that the address 120 “A” is after the entry generation 906 for address “A” and the flow can progress to the entry update 912. The entry update can assign the stride increment 218 with the difference 926. The stride count 220 can be incremented by one. The last training address 212 can be assigned this address 120 “A” as the region offset. The flow can progress to the count query 914.

For this example, the pattern threshold 928 is assigned to a high value such that a single-stride pattern 128 is not detected—for brevity and clarity to describe the multi-stride pattern 130 detection. So far, with “A”, the stride count 220 is 1 and that value does not meet the pattern threshold 928 to transfer this training entry 206 to the prefetch pattern information 204. The flow can loop back to the address input 902 to continue to process the next address 120 from the address stream 126.

The address 120 is now “A+2”. The flow progresses through the new region query 904 to the stride computation 908. The stride computation 908 calculates the difference 926 to be 2. The flow can progress to the stride query 910. The stride query 910 determines that the difference 926 is different than the stride increment 218 of 1, which was calculated for the previous address 120. At this point, the flow can progress to the pattern update 918.

The pattern update 918 can utilize another training state 210 for the training entry 206 being used for training As an example, the pattern update 918 can utilize a previously unused training state 210 by setting its state valid bit 222 to indicate a valid training state. The pattern update 918 can assign the stride increment 218 for this training state 210 with the difference 926.

Relating back to the earlier figures as examples, the use of another training state 210 can be described as shifting the previous training state 210 or atom 302 to the left as described in FIG. 7. The previous training state 210 can be considered the first atom 404 shown in FIG. 4. The flow can progress to the state query 920.

In this example, the state query 920 determines the training entry 206 being used for training is not ready for speculative fetching and the flow can progress to loop back to the address input 902. The address input 902 processes the address 120 “A+4”. Continuing with this example, the flow can progress similarly as described earlier to generate the training entry 206 with the training states 210 for the first atom 404, the second atom 406 of FIG. 4, the third atom 408 of FIG. 4, the fourth atom 410 of FIG. 4 and the fifth atom 412 of FIG. 4.

Further while the atoms 302 are being generated while processing this address stream 126, the multi-stride detectors 304 of FIG. 3 can be utilized to detect the multi-stride pattern 130. These multi-stride detectors 304 can be utilized for a correlation-based detection to detect patterns from these atoms 302.

The address stream 126 can be represented by a pair of values for each training state 210 or each atom 302. The pair could be represented by the stride increment 218 and the stride count 220. A vector with these pairs can be used to represent the address stream 126.

In this example, the vector [+1, 1, +2, 2, +3, 2, +2, 2, +3, 2] can represent the address stream 126. The notation [a, b] represents one atom 302 with a as the stride increment 218 and b as the stride count 220. As a general description, let n be the length of the vector. As a specific example, n is a multiple of 2. In this example, n=10.

Each of the multi-stride detectors 304 with its comparators 306 of FIG. 3 can perform the compare function as vector[i−2 k] to vector[i], where i=n . . . n−2 k−1 and k=2 . . . floor(n/(2*2)). For this example, floor(10/(2*2))=floor(2.5)=2, so 2 is the value k takes. If at any value of k there is a match, then an embodiment take the last 2 k elements of the vector and these 2 k elements provide the recurring pattern for a multi-stride pattern 130.

Continuing with this example, the recurring pattern will be detected as [+2, 2, +3, 2]. The multi-stride detectors 304 or as a specific example the comparators 306 can correlate a trailing edge 932 in the address stream 126 to filter out the anomalies at a leading edge 934 in the address stream 126.

The leading edge 934 is a previously processed portion of the address stream 126 used for training The leading edge 934 can be spurious addresses 120 that can be ignored to improve detection of single-stride pattern 128 or multi-stride pattern 130. As an example, the leading edge 934 can be at the very beginning of the address stream 126 being used for training or it can be elsewhere in the address stream 126. Also for example, the leading edge 934 can be considered spurious when the address 120 is not part of a pattern, such as a single-stride pattern 128 or a multi-stride pattern 130.

The trailing edge 932 is a portion of the address stream 126 being used for training but not at the very beginning of the address stream 126. As an example, the trailing edge 932 follows at least one address 120 in the address stream 126. As a further example, the trailing edge 932 can be the last few addresses 120 in the address stream 126 or the last few address streams 126 as observed by the prefetch module 112.

In this example, the training state 210 for the first atom 404 can capture an anomaly at the leading edge 934. Any number of these anomalies at the leading edge 934 can be filtered by various embodiments. As an example, the prefetch module 112 can utilize 2 m training states 210 in one training entry 206 to be able to detect an m-stride pattern.

To further this example using the illustration in FIG. 3, a number of multi-stride detectors 304 are shown where some can utilize all the atoms 302 generated thus far while others can use a subset or the most recent generated atoms 302 to look at the trailing edge 932 while ignoring the leading edge 934.

Using the example in FIG. 3, the five-stride detector 314 of FIG. 3 compares all the atoms 302. The two-stride detector 308 of FIG. 3 through the four-stride detector 312 of FIG. 3 compare the most recently generated atoms 302 while ignoring some portion of the address stream 126 as the leading edge 934 while comparing the trailing edge 932. In other words as an example, as the atoms 302 shift to the left as shown in FIG. 3, the leftmost atoms 302 can be ignored by the two-stride detector 308.

Similarly, the example in FIG. 8 further depicts the capability to tolerate anomalies in the leading edge 934 while processing the trailing edge 932. In this example, the three-stride detector 310 of FIG. 8 depicts comparison with the third atom 408 of FIG. 8 through the eighth atom 806 of FIG. 8. These atoms 302 in this example can represent comparing the trailing edge 932 of the address stream 126 represented in these atoms 302.

Continuing with the example in FIG. 8, the three-stride detector 310 does not compare the first atom 404 of FIG. 8 and the second atom 406 of FIG. 8. These atoms 302 in this example can represent the leading edge 934 being filtered in scenarios where these atoms 302 can have anomalies.

Further with the example in FIG. 8, the four-stride detector 312 of FIG. 8 does compare the first atom 404 and the second atom 406 with the other atoms 302. This allows the four-stride detector 312 to compare the entire address stream 126 processed thus far. The comparison can occur regardless of a presence of an anomaly or not. The four-stride detector 312 just will not detect a pattern if there is an anomaly. The four-stride detector 312 can detect a four-stride pattern using eight atoms 302.

It has been discovered that the computing system 100 or the prefetch module 112 can detect arbitrary complex patterns accurately and quickly without predetermined patterns. The adding of the training states 210 and the representative shifting of the atoms 302 allows for continued training as patterns changes in the address stream 126.

It has been discovered that the computing system 100 or the prefetch module 112 provide rapid fetching/prefetching while improving pattern detection. Embodiments can quickly start speculatively prefetching or fetching program data 114 as a single-stride pattern 128 while the prefetch module 112 can continue to train for a longer single-stride pattern 128 or a multi-stride pattern 130. The pattern threshold 928 can be used to provide rapid deployment of the training entry 206 for fetching/prefetching a single-stride pattern 128. The multi-stride threshold 930 can be used to provide rapid deployment of the training entry 206 for fetching/prefetching a multi-stride pattern 130.

It has been discovered that the computing system 100 or the prefetch module 112 can improve pattern detection by auto-correlate with the addresses 120. The multi-stride detectors 304 and the comparators 306 therein can be used to auto-correlate patterns based on the address 120 in the address stream 126. The auto-correlation allows for detection for the trailing edge 932 in the address stream 126 within a region even in the presence of accesses at the leading edge 934 unrelated to the pattern that precede the pattern.

It has been discovered that the computing system 100 or the prefetch module 112 improved pattern detection by continuously comparing the trailing edge 932 of the address stream 126. Embodiments can process the address stream 126 with the atoms 302. This allows embodiments to avoid being confused or missing spurious accesses for the program data 114 or the address 120 at the beginning of the address stream 126.

It has been discovered that the computing system 100 or the prefetch module 112 provides reliable detection of patterns in the address stream 126 that is area and power-efficient for hardware implementation. The utilization of one training entry 206 for detecting a single-stride pattern 128 or a multi-stride pattern 130 uses hardware for both purposes avoiding redundant hardware. The utilization of one training entry 206 with multiple training states 210 uses the same hardware for information shared for single-stride pattern 128 detection and multi-stride pattern 130 detection, such as the tag 208 or the last training address 212. The avoidance of redundant hardware circuitry leads to less power consumption.

It has been discovered that the computing system 100 or the prefetch module 112 can efficiently use the training state 210 or atom 302 for concurrent single-stride pattern 128 detection while shorter time to perform speculative fetching/prefetching. Embodiments can transfer or copy the training entry 206 when the pattern threshold 928 is met allowing for speculatively fetching/prefetching. However, the embodiments can continue to train for longer stride for the same single-stride pattern 128 allowing use of the same training state 210 and atom 302. This also has the added benefit of efficient power and hardware savings.

It has been discovered that the computing system 100 or the prefetch module 112 is extensible to detect complex patterns in the address stream 126 by extending the number of comparators 306 used in a multi-stride detector 304.

The modules described in this application can be hardware implementations or hardware accelerators in the computing system 100. The modules can also be hardware implementation or hardware accelerators within the computing system 100 or external to the computing system 100.

The modules described in this application can be implemented as instructions stored on a non-transitory computer readable medium to be executed by the computing system 100. The non-transitory computer medium can include memory internal to or external to the computing system 100. The non-transitory computer readable medium can include non-volatile memory, such as a hard disk drive, non-volatile random access memory (NVRAM), solid-state storage device (SSD), compact disk (CD), digital video disk (DVD), or universal serial bus (USB) flash memory devices. The non-transitory computer readable medium can be integrated as a part of the computing system 100 or installed as a removable portion of the computing system 100.

Referring now to FIG. 10, FIG. 10 depicts various example embodiments for the use of the computing system 100, such as in a smart phone, the dash board of an automobile, and a notebook computer.

These application examples illustrate the importance of the various embodiments of the present invention to provide improved processing performance while minimizing power consumption by reducing unnecessary interactions requiring more power. In an example where an embodiment of the present invention is an integrated circuit processor and the cache module 108 is embedded in the processor, then accessing the information or data off chip requires more power than reading the information or data on-chip from the cache module 108. Various embodiments of the present invention can filter unnecessary prefetch or off-chip access to reduce the amount of power consumed while still prefetching what is needed, e.g. misses in the cache module 108, for improved performance of the processor.

The computing system 100, such as the smart phone, the dash board, and the notebook computer, can include one or more of a subsystem (not shown), such as a printed circuit board having various embodiments of the present invention or an electronic assembly having various embodiments of the present invention. The computing system 100 can also be implemented as an adapter card.

Referring now to FIG. 11, therein is shown a flow chart of a method 1100 of operation of a computing system 100 in an embodiment of the present invention. The method 1100 includes: training to concurrently detect a single-stride pattern or a multi-stride pattern from an address stream in a block 1102; speculatively fetching a program data based on the single-stride pattern or the multi-stride pattern in a block 1104; and continuing to train for the single-stride pattern with a larger value for a stride count or for a multi-stride pattern in a block 1106.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
an instruction dispatch module configured to receive an address stream;
a prefetch module, coupled to the instruction dispatch module, configured to:
train to concurrently detect a single-stride pattern or a multi-stride pattern from the address stream,
speculatively fetch a program data based on the single-stride pattern or the multi-stride pattern, and
continue to train for the single-stride pattern with a larger value for a stride count or for the multi-stride pattern.

2. The system as claimed in claim 1 wherein the prefetch module is configured to:
speculatively fetch based on a difference in a stride increment in the address stream; and
continue to train based on the difference.

3. The system as claimed in claim 1 wherein the prefetch module is configured to correlate a trailing edge of the address stream.

4. The system as claimed in claim 1 wherein the prefetch module is configured to filter out a leading edge of the address stream.

5. The system as claimed in claim 1 wherein the address stream includes unique accesses from a cache module for an address.

6. The system as claimed in claim 1 wherein the prefetch module is configured to update the speculatively fetching the program data based on the single-stride pattern with the larger value for the stride count.

7. The system as claimed in claim 1 wherein the prefetch module is configured to:
utilize a training entry including a training state for the single-stride pattern; and
utilize a different training state in the training entry for the multi-stride pattern.

8. The system as claimed in claim 1 wherein the prefetch module is configured to concurrently detect different multi-stride patterns.

9. The system as claimed in claim 1 wherein the prefetch module is configured to extend the training.

10. The system as claimed in claim 1 wherein the prefetch module is configured to train from the address stream within a region.

11. A method of operation of a computing system comprising:
training to concurrently detect a single-stride pattern or a multi-stride pattern from an address stream;
speculatively fetching a program data based on the single-stride pattern or the multi-stride pattern; and
continuing to train for the single-stride pattern with a larger value for a stride count or for the multi-stride pattern.

12. The method as claimed in claim 11 wherein:
speculatively fetching the program data based on the single-stride pattern includes speculatively fetching based on a difference in a stride increment in the address stream; and
continuing to train for the multi-stride pattern includes continuing to train based on the difference.

13. The method as claimed in claim 11 wherein training to concurrently detect the multi-stride pattern includes correlating a trailing edge of the address stream.

14. The method as claimed in claim 11 wherein training to concurrently detect the multi-stride pattern includes filtering out a leading edge of the address stream.

15. The method as claimed in claim 11 wherein the address stream includes unique accesses from a cache module for an address.

16. The method as claimed in claim 11 further comprising updating the speculatively fetching the program data based on the single-stride pattern with the larger value for the stride count.

17. The method as claimed in claim 11 wherein training to concurrently detect the single-stride pattern or the multi-stride pattern includes:
utilizing a training entry including a training state for the single-stride pattern; and
utilizing a different training state in the training entry for the multi-stride pattern.

18. The method as claimed in claim 11 wherein training to concurrently detect the multi-stride pattern includes concurrently detecting different multi-stride patterns.

19. The method as claimed in claim 11 wherein training to concurrently detect the multi-stride pattern includes extending the training.

20. The method as claimed in claim 11 wherein training to concurrently detect the single-stride pattern or the multi-stride pattern includes training from the address stream within a region.
